(19) United States
(12) Patent Application Publication
(10) Pub. No.: US 2012/0292478 A1
(43) Pub. Date: Nov. 22, 2012

(54) EXHAUST MOUNTING DEVICE AND MOTOR VEHICLE

(75) Inventor: Lutz UHLENBRUCH, Herbstein (DE)

(73) Assignee: GM GLOBAL TECHNOLOGY OPERATIONS LLC, Detroit, MI (US)

(21) Appl. No.: 13/474,953

(22) Filed: May 18, 2012

(30) Foreign Application Priority Data
May 20, 2011 (DE) 10 2011 102 099.7

(51) Int. Cl. B60R 11/00

(52) U.S. Cl. 248/638

(57) ABSTRACT

An exhaust mounting device for attaching an exhaust device to a vehicle body element of a motor vehicle is provided. The exhaust mounting device includes a holder. The holder has an outer side and a fastening element on the outer side. The holder is configured for fastening the exhaust mounting device on the vehicle body element. A damper device is arranged in the holder.

### CROSS-REFERENCE TO RELATED APPLICATION

This application claims priority to German Patent Application No. 10 2011 102 099.7, filed May 20, 2011, which is incorporated herein by reference in its entirety.

### TECHNICAL FIELD

The technical field generally relates to an exhaust mounting device and a motor vehicle.

### BACKGROUND

An insulation for an exhaust system of a vehicle is described in U.S. Pat. No. 7,510,043 B3. The insulation is implemented therein in such a manner that it fits directly into a hole, which is formed in a support structure of the vehicle. A rod extends between an elastic insulation, which is arranged in the hole, and a part of the vehicle. Such an insulation must first be pressed into the support structure of the vehicle, before the exhaust system can subsequently be connected to the insulation in order to fasten the exhaust system of the vehicle.

### SUMMARY

An exhaust mounting device for attaching an exhaust device to a vehicle body element of a motor vehicle, e.g., a front axle subframe or the subfloor, etc., is provided. In an embodiment, the exhaust mounting device has a holder for a damper device, which has a fastening element on its outer side. The fastening element is designed for the purpose of fastening the exhaust mounting device on the vehicle body element.

A motor vehicle having a vehicle body part, e.g., a front axle subframe or the subfloor, etc., and having an exhaust device has an exhaust mounting device according to an embodiment for attaching the exhaust device to the vehicle body part of the motor vehicle.

The exhaust mounting device according to an embodiment is fastened very easily by the fastening element on the outer side of the holder, on the vehicle body element, e.g., a front axle subframe or the subfloor, etc., without additional parts, and if needed can already be connected to the exhaust device before the fastening to the vehicle body element. In this way, the exhaust device can also be fastened jointly with the respective exhaust mounting device on the vehicle body element.

The exhaust mounting device is provided with a fastening element, with which the exhaust device can be fastened on the vehicle body element, e.g., a front axle subframe or the subfloor, etc.

In an embodiment, the fastening element is implemented as a screw-in element, in particular as a screw or a threaded bolt, which is fastened on the holder in particular by welding, soldering, and/or a screw connection. The use of a screw-in element is cost-effective and particularly simple to fasten.

According to another preferred embodiment, the damper device has a receptacle for accommodating an exhaust holder of the exhaust device. The receptacle is in particular implemented in this case as a depression or as a through opening, into which the exhaust holder is insertable.

In a further embodiment, the damper device is implemented as a rubber mount, the rubber mount in particular having an outer rubber ring and an inner rubber ring, which are connected to one another via a membrane, in particular a rubber membrane. The rubber mounting device represents a simple and cost-effective possibility for damping the suspension of the exhaust device.

In another embodiment, the holder is implemented as a ring element, in particular a metal ring. The embodiment of a metal ring as the holder is particularly stable and cost-effective.

In one embodiment, the exhaust device has an exhaust having an exhaust pipe, the exhaust pipe having an exhaust holder on a side in each case, which can be accommodated by the exhaust mounting device, the exhaust holder being fastened on the exhaust pipe. The exhaust pipe preferably alternately additionally has an insulation, which acts as a heat shield.

The vehicle body element is typically implemented as a front axle frame or front axle subframe or as a subfloor.

In an embodiment, the vehicle body element has an opening, in particular a through opening, for guiding through the fastening element of the holder of the exhaust mounting device. The fastening element is guided through the opening of the vehicle body element from one side and is fastened to this vehicle body element from the other side of the vehicle body element. Through the combination of screw-in element and nut, a particularly simple and cost-effective fastening of the exhaust mounting device on the exhaust device can be provided. It addition, the exhaust mounting device can be positioned by the screw-in element and an exhaust device connected thereto beforehand in the opening of the vehicle body element and subsequently fastened by the attachment of the nut to the vehicle body element, e.g., a front axle subframe or the subfloor, etc. In addition, other objects, desirable features and characteristics will become apparent from the subsequent summary and detailed description, and the appended claims, taken in conjunction with the accompanying drawings and this background.

### BRIEF DESCRIPTION OF THE DRAWINGS

The various embodiments will hereinafter be described in conjunction with the following drawing figures, wherein like numerals denote like elements, and wherein:

FIG. 1 shows a perspective view of a vehicle body element of the vehicle, on which an exhaust device is fastened by means of exhaust mounting devices according to an embodiment;

FIG. 2 shows a side view of the fastening of the exhaust device by the exhaust mounting devices according to FIG. 1; and

FIG. 3 shows a sectional view of the fastening of the exhaust device by an exhaust mounting device according to FIG. 2.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

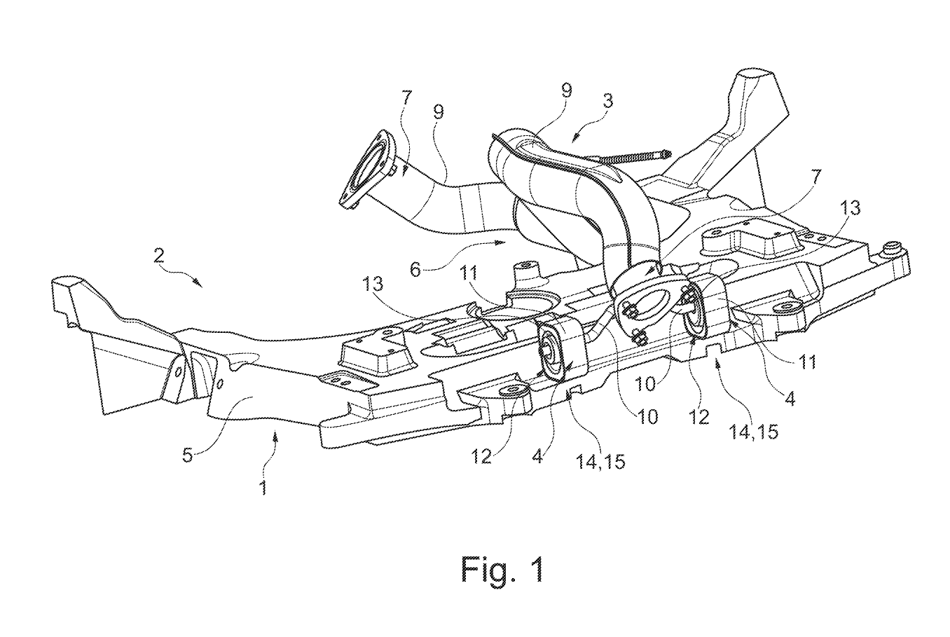

FIG. 1 shows a perspective view of a vehicle body part or vehicle body element 1 of the vehicle 2, on which the exhaust device 3 is fastened by an exhaust mounting devices 4 according to an embodiment. The vehicle body element 1 shown in the exemplary embodiment in FIG. 1 is, for example, a front axle frame or a front axle subframe 5, which is attachable to the remaining vehicle body and in particular to the front frame.

The exhaust device 3, which has an exhaust 6 having an exhaust pipe 7, is fastened on the front axle subframe 5. As shown in the exemplary embodiment in FIG. 1, the exhaust pipe 7 can additionally optionally be provided with an additional exhaust insulation 9, which is used as the heat shield.

To fasten the exhaust device 3, the exhaust pipe 7 has an exhaust holder 10 on each side, for example, a metal rod or a metal pipe. The exhaust holder 10 is fastened on the exhaust pipe 7 in this case, for example, by welding, soldering, and/or clamping, e.g., by means of a clamp element, which can be fastened or clamped on the exhaust pipe 7 similarly to an exhaust clamp.

To fasten the exhaust device 3 on the front axle subframe 5, the respective exhaust holder 10 is accommodated or inserted in the assigned exhaust mounting device 4. The exhaust mounting device 4 has a holder in this case, for example, in the form of a ring element 11, in particular a metal ring, for fastening on the vehicle body element 1, e.g., the front axle subframe 5 in the exemplary embodiment in FIG. 1. However, the embodiment is not restricted to a front axle subframe 5 as the vehicle body part 1. The vehicle body part can also be, e.g., the subfloor of the vehicle or another part of the vehicle body, which is suitable for fastening the exhaust device 3 thereon. A damper device 12, for example, a rubber mounting device 13, can be arranged in the holder or ring element 11, in which the exhaust holder 10 is accommodated. The damper device 12 is used to dampen the fastening of the exhaust device 3 on the vehicle body.

For fastening the exhaust mounting device 4 on the vehicle body element 1, for example, the front axle subframe 5 in the exemplary embodiment in FIG. 1, a fastening element is provided on the holder or ring element 11, e.g., a screw-in element, such as a threaded bolt 14. The threaded bolt 14 is fastened on the ring element 11, for example, welded, soldered, and/or screwed on. The threaded bolt 14 of the ring element 11 is guided through an opening of the front axle frame 5, whereby the exhaust mounting device 4 and the exhaust device 3 connected thereto can be positioned beforehand on the front axle subframe 5. Subsequently, the threaded bolt 14 can be secured by a nut 15 from the other side of the opening on the front axle subframe 5. Instead of a threaded bolt 14, a screw (not shown) can also be used as the screw-in element.

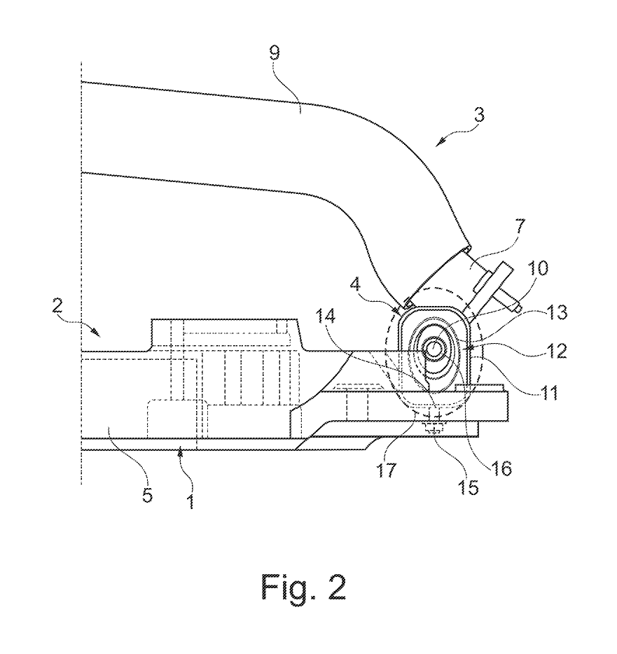

FIG. 2 shows a side view of the fastening of the exhaust device 3 on the front axle subframe 5 by the exhaust mounting devices 4 according to FIG. 1. The respective exhaust mounting device 4 is fastened with its damper device 12 directly on the front axle subframe 5, including the threaded bolt 14. A rubber mounting device 13 can be provided as the damper device 12, which is accommodated in the holder or ring element 11 of the respective exhaust mounting device 4 and has a receptacle, e.g., in the form of a through opening 16, for accommodating an assigned exhaust holder 10 of the exhaust device 3. Instead of a through opening 16, a depression (not shown) can also be provided as the receptacle.

The threaded bolts 14 of the ring element 11 or holders of the exhaust mounting devices 4 are inserted through an opening 17 in a section of the front axle subframe 5 in order to position the exhaust mounting device 4 beforehand. The exhaust mounting devices 4 can already be connected to the exhaust device 3, so that the exhaust device 3 can be fastened completely on the front axle subframe 5. After the positioning, the threaded bolts 14 are secured on the front axle subframe 5 from the other side thereof, for example, by the nuts 15. The exhaust holders 10 are already accommodated in the exhaust mounting devices 4, the exhaust holders 10 being inserted into the assigned openings 16 of the damper devices 12 of the exhaust mounting devices 4. The exhaust mounting devices 4 are then fastened with the exhaust device 3, as described above, by the threaded bolts 14 and the nuts 15 on the front axle subframe 5.

One or both exhaust mounting devices 4 can initially also be fastened on the front axle subframe 5 and subsequently the exhaust holders 10 of the exhaust device 3 can be accommodated in the exhaust mounting device(s) 4.

Installation sequences other than those described above are also possible.

The advantage of fastening the exhaust device 3 by the exhaust mounting devices 4 is that weight and parts can be saved. In particular, the exhaust device 3 can be fastened very easily on the front axle subframe 5 and subsequently the front axle subframe 5 can be fastened together with the exhaust device 3 on the vehicle body, e.g., the front frame or front main frame.

Furthermore, a maximal integration of parts is achieved in the area of the vehicle body and its front axle, as well as a cost reduction, because the previously used stainless steel bridges for fastening the exhaust are no longer necessary to fasten the exhaust on the vehicle.

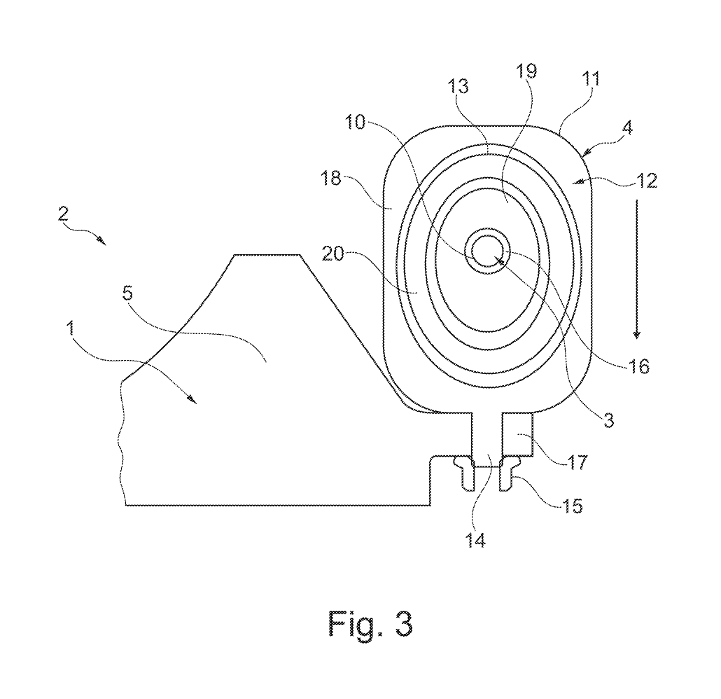

FIG. 3 shows a sectional view of the fastening of the exhaust device 3 by an exhaust mounting device 4 according to FIG. 2. The exhaust mounting device 4 has the ring element 11 as a holder, on whose outer side, for example, the threaded bolt 14 is fastened, e.g., by welding, soldering, and/or a screw connection, etc. The ring element 11 is, for example, a metal ring or produced from another suitable material or material combination. The damper device 12 is accommodated in the ring element 11 for damping the suspension of the exhaust device 3.

The damper device 12 is a rubber mounting device 13 in the exemplary embodiment in FIG. 3. The rubber mounting device 13 in the exemplary embodiment in FIG. 3 has, for example, an outer rubber ring 18 and an inner rubber ring 19 having a rubber membrane 20, which connects the outer and inner rubber rings 18, 19.

The exhaust holder 10 of the exhaust device 3 is accommodated in the inner rubber ring 19. The rubber material of the rubber mounting device 13 can be or comprise hard rubber or another material capable of damping. The embodiment is not restricted to a rubber mounting device 13 as the damper device 12, however. Fundamentally, any other damper device 12 can be provided, which is capable of being coupled to the exhaust device 3 and damping the suspension of the exhaust device 3. Furthermore, the embodiment is also not restricted to the special embodiment of the rubber mounting device 13, as is described in particular with reference to FIG. 3, but rather any other rubber mounting device can be used, which is capable of being coupled to an exhaust device 3 and damping the suspension of the exhaust device 3. As described above with reference to FIG. 1, the exhaust holder 10 is fastened laterally on the exhaust pipe of the exhaust of the exhaust device 3, for example, by welding, soldering, and/or clamping, e.g., by means of a clamp element, which can be arranged enclosing the pipe and can be fixed, and carries the exhaust holder, similarly to an exhaust clamp.

The exhaust mounting device 4 is guided using the threaded bolt 14 through an opening 17, for example, a through hole of the front axle subframe 5. The threaded bolt 14 is subsequently secured from the other side of the front axle subframe 5, for example, using a nut 15. The direction of the load is shown by an arrow in FIG. 3.

As shown in the exemplary embodiment in FIG. 3, the exhaust holder 10 of the exhaust device 3 can already be accommodated in the opening 16 of the inner rubber ring 19 of the rubber mounting device 13. The exhaust holder 10 can also be accommodated, after the exhaust mounting device 4 has been fastened on the front axle subframe 5, in the opening 16 of the inner rubber ring 19 of the rubber mounting device 13.

Instead of, as in the exemplary embodiments in FIGS. 1, 2, and 3, fastening the exhaust mounting devices 4 on the upper side of the vehicle body element 1, e.g., the front axle subframe 5, the exhaust mounting devices 4 can also be fastened on the other side, i.e., the lower side or the floor side of the vehicle body element 1.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. An exhaust mounting device for attaching an exhaust device to a vehicle body element of a motor vehicle, the exhaust mounting device comprising:
a holder, wherein the holder has an outer side and a fastening element on the outer side, wherein the holder is configured for fastening the exhaust mounting device on the vehicle body element; and
a damper device arranged in the holder.

2. The exhaust mounting device according to claim 1, wherein the fastening element is implemented as a screw-in element that is fastened on the holder.

3. The exhaust mounting device according to claim 1, wherein the damper device has a receptacle for accommodating an exhaust holder of the exhaust device, the receptacle being implemented as a depression and/or as a continuous opening.

4. The exhaust mounting device according to claim 3, wherein the damper device is implemented as a rubber mount, which has an outer rubber ring and an inner rubber ring, which are connected to one another via a membrane.

5. The exhaust mounting device according to claim 1 wherein the holder is implemented as a ring element.

6. A motor vehicle comprising:
a vehicle body element;
an exhaust device; and
an exhaust mounting device configured for attaching the exhaust device to the vehicle body element of the motor vehicle, the exhaust mounting device comprising:
a holder, wherein the holder has an outer side and a fastening element on the outer side, wherein the holder is configured for fastening the exhaust mounting device on the vehicle body element; and
a damper device arranged in the holder.

7. The motor vehicle according to claim 6, wherein the vehicle body element has an opening for guiding through the fastening element, and the fastening element is guided from one side through the opening of the vehicle body element and is fastened on the vehicle body element from the other side of the vehicle body element.

8. The motor vehicle according to claim 6, wherein the vehicle body element is a front axle subframe or a subfloor.

9. The motor vehicle according claim 6, wherein the exhaust device has an exhaust having an exhaust pipe, the exhaust pipe having an exhaust holder on a side, wherein the exhaust holder can be accommodated by the exhaust mounting device, the exhaust holder being fastened on the exhaust pipe.

10. The motor vehicle according to claim 9, wherein the exhaust pipe has an insulation configured as a heat shield.
